(19) United States
(12) Patent Application Publication
(10) Pub. No.: US 2022/0179908 A1
(43) Pub. Date: Jun. 9, 2022

(54) INFORMATION SECURITY DEVICE AND METHOD THEREOF

(71) Applicant: INSTITUTE FOR INFORMATION INDUSTRY, Taipei (TW)

(72) Inventors: Te-En WEI, Taipei (TW); Shin-Ying HUANG, Taipei (TW); Hsiao-Hsien CHANG, Taipei (TW); Jain-Shing WU, Taipei (TW)

(21) Appl. No.: 17/110,329

(22) Filed: Dec. 3, 2020

(51) Int. Cl. G06F 16/901; G06F 16/951; G06F 16/903; G06F 16/9035; G06K 9/62; H04L 29/06

(52) U.S. Cl. CPC G06F 16/9024; G06F 16/951; H04L 63/1433; G06F 16/9035; G06K 9/6215; G06F 16/90344

(57) ABSTRACT

An information security device and method thereof are provided. The information security device includes a transceiver, a register and a processor. The transceiver configured to receive scenario information of a company; The register configured to store multiple instructions and multiple databases; and the processor coupled to the transceiver and the register, and configured to execute the multiple instructions to: read first vulnerability related information and first event information from the multiple databases; generate at least one first intelligent graph according to the first vulnerability related information and the first event information, and generate a second intelligent graph according to the scenario information; and compare the at least one first intelligent graph with the second intelligent graph to identify at least one similarity between the at least one first intelligent graph and the second intelligent graph for determining whether the company has information security threat.

### BACKGROUND

### Field of Disclosure

The present disclosure relates to information security technology. More particularly, the present disclosure relates to information security device and method thereof.

### Description of Related Art

In general, the diversity and variability of information security threats is high, and it is quite labor intensive to filter and overcome threat information, so it is necessary to filter out irrelevant information with the assistance of technology. In addition, although online social media is a rich source of the threat information, news media, information security companies, government organizations, information security communities, and information circulating on the internet are often mixed with other information.

Therefore, how to obtain the threat information and to filter and overcome the threat information is an urgent problem for those skilled in the art to solve.

### SUMMARY

The disclosure provides an information security device, comprising a transceiver, a register and a processor. The transceiver configured to receive scenario information of a company; The register configured to store a plurality of instructions and a plurality of databases; and the processor coupled to the transceiver and the register, and configured to execute the plurality of instructions to: read first vulnerability related information and first event information from the plurality of databases; generate at least one first intelligent graph according to the first vulnerability related information and the first event information, and generate a second intelligent graph according to the scenario information; and compare the at least one first intelligent graph with the second intelligent graph to identify at least one similarity between the at least one first intelligent graph and the second intelligent graph for determining whether the company has information security threat.

The disclosure provides an information security method. the method comprises: reading first vulnerability related information and first event information from a plurality of databases; generating at least one first intelligent graph according to the first vulnerability related information and the first event information, and generate a second intelligent graph according to the scenario information; and calculating at least one match degree between the at least one first intelligent graph and the second intelligent graph for determining whether the company has information security threat.

Based on above, the embodiment of the present disclosure can compare the intelligence of the scenario and the intelligence of the information security event to quickly filter the information security event of the scenario. In addition, the embodiment of the present disclosure further uses the intelligence graph corresponding to the scenario and the intelligence graph corresponding to the information security event to perform graph matching analysis, so as to identify the vulnerability of the scenario that will be attacked in the future.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of an information security device according to an embodiment of the present disclosure,

FIG. 2 is a schematic diagram of an information security method according to an embodiment of the present disclosure,

FIG. 3 is a flowchart of the information security method according to an embodiment of the present disclosure,

FIG. 4 is a schematic diagram of a first intelligent subgraph according to an embodiment of the present disclosure, and

FIG. 5 is a schematic diagram of a second intelligent subgraph according to an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

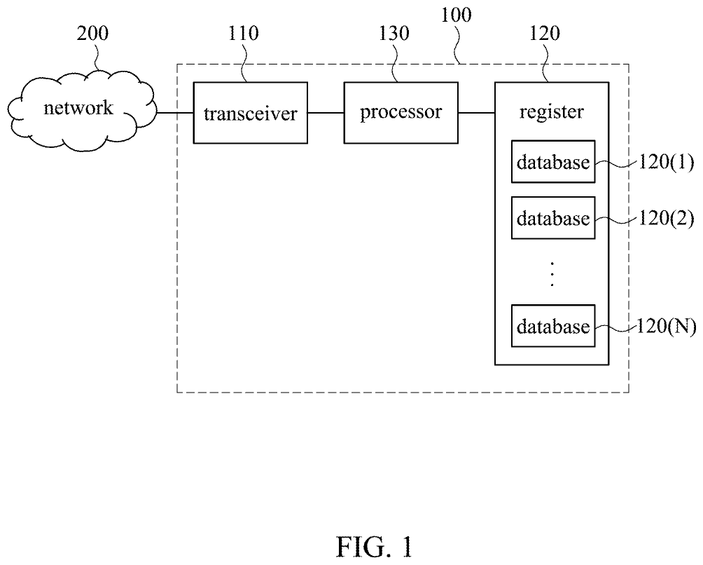

FIG. 1 is a block diagram of an information security device according to an embodiment of the present disclosure. Referring to FIG. 1, an information security device 100 includes a transceiver 110, a register 120 and a processor 130. The transceiver 110 is configured to receive scenario information of a company. In detail, the transceiver 110 can receive many types of information about the company as the scenario information. In some embodiments, the scenario information includes device model, data flow, host logs and file logs etc., which are related to devices and information of the company. In some embodiments, the company can be enterprise unit, organization unit, institution unit or government unit, etc.

Furthermore, the register 120 is configured to store multiple instructions and multiple databases 120(1)˜120(N), where N can be any positive integer, but is not limited to this. The processor 130 is coupled to the transceiver 110 and the register 120, and configured to execute the multiple instructions.

In some embodiments, the transceiver 110 can receive the scenario information of the company in a wireless or wired manner, and can also perform operations such as low-noise amplification, impedance matching, mixing, up or down frequency conversion, filtering, amplification, etc., so as to obtain the scenario information from a network 200.

In some embodiments, the transceiver 110 is, for example, a transmitter circuit, an analog-to-digital (A/D) converter, a digital-to-analog (D/A) converter, a low noise amplifier, a mixer, filters, impedance matchers, transmission lines, power amplifiers, one or a combination of one or more antenna circuits and local storage media components.

In some embodiments, the register 120 can be, for example, any type of fixed or removable random access memory (RAM), read-only memory (ROM), flash memory (flash memory), hard disk drive (HDD), solid state drive (SSD) or similar components or a combination of the above components.

In some embodiments, the processor 130 is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), arithmetic logic unit (ALU), complex programmable logic device (CPLD), field programmable gate array (FPGA) or other similar components or combinations of the above components.

In some embodiments, the processor 130 can be coupled to the transceiver 110 and the register 120 in a wired or wireless manner.

For the wired method, the above-mentioned coupled method can be through universal serial bus (USB), RS232, universal asynchronous receiver/transmitter (UART), internal integration Circuit (I2C), serial peripheral interface (SPI), display port (display port), thunderbolt (thunderbolt) or local area network (LAN) interface coupled method.

For the wireless method, the above-mentioned coupled method can be through wireless fidelity (Wi-Fi) module, radio frequency identification (RFID) module, Bluetooth module, infrared radiation (IR) module, near-field communication (NFC) module or device-to-device (D2D) module coupled method.

In some embodiments, the processor 130 can search and receive, through the transceiver 110, sample social media data from various social media websites (e.g. twitter or facebook), various news websites (e.g. CERT-EU), various forum websites (e.g. 0 day.today) or other similar websites or databases.

In some embodiments, the processor 130 can search and receive, through the transceiver 110, first vulnerability related information and first event information from various open source software vulnerability information databases (e.g. national vulnerability database (NVD), common vulnerabilities and exposures database (CVE), open source vulnerability database (OSVDB), exploit database (Exploit-DB) or vulnerability database (VulDB)) or various social media websites. The processor 130 can even receive, through the transceiver 110, first vulnerability related information which is information of software vulnerabilities happened in the past and input by a user.

In some embodiments, the processor 130 can search and receive, through the transceiver 110, indicator of compromise (IOC) data from various open source or commercial IOC databases.

In further embodiments, the processor 130 can store the sample social media data, the first vulnerability related information, the first event information and the IOC data to the databases 120(1)˜120(N).

In further embodiments, the sample social media data includes texts about social media (e.g. the text includes account, tweets, tags, title, author, content and time etc.).

In further embodiments, the first vulnerability related information includes various vulnerabilities and information related to attack methods, operating systems, threat types and threat levels etc., where attack methods, operating systems, threat types and threat levels etc. correspond to the various vulnerabilities.

In further embodiments, the first event information includes various information security logs which is corresponding to events happened in the past, where the information security log includes attack methods (e.g. DarkHotel APT), infrastructures of the attack methods, the vulnerabilities (e.g. CVE-2019-1367) corresponding to the attack methods and exploitations (e.g. CVE-2019-1367 in the wild exploitation) of the various vulnerabilities.

In further embodiments, the IOC data includes various raw data of IOC.

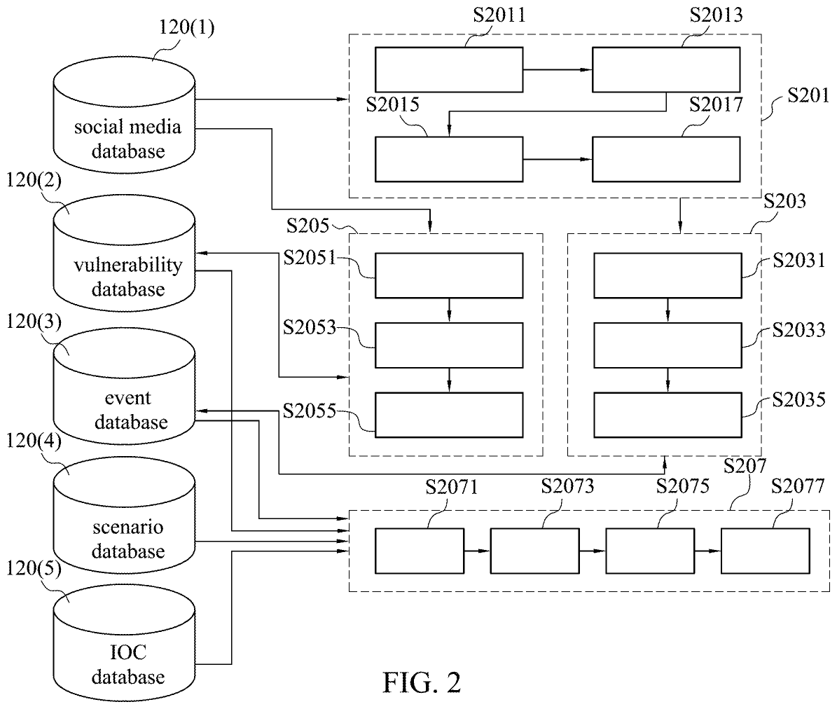

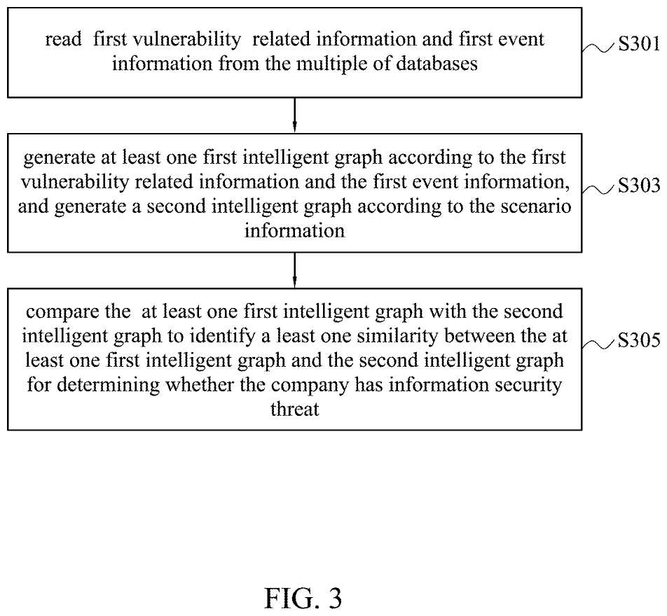

FIG. 2 is a schematic diagram of an information security method according to an embodiment of the present disclosure. FIG. 3 is a flowchart of the information security method according to an embodiment of the present disclosure. The method of the embodiment shown in FIG. 3 is applicable to the information security device 100 in FIG. 1, but is not limited to this. For the sake of convenience and clear description, the detailed steps of the information security method shown in FIG. 3 can be described in the following with reference to FIG. 1, FIG. 2 and FIG. 3 at the same time.

In step S301, the processor 130 can read first vulnerability related information and first event information from the databases 120(1)˜120(N).

In other words, the processor 130 can search the first vulnerability related information and the first event information in the databases 120(1)˜120(N).

In some embodiments, before the processor 130 reads the first vulnerability related information and the first event information from the databases 120(1)˜120(N), the processor 130 can receive social media data through the transceiver, and calculate multiple relevancy scores of the social media data according to the sample social media data of the databases 120(1)˜120(N), where the multiple relevancy scores indicate correlation between the social media data and information security. By this way, the processor 130 can identify text data from the social media data according to the multiple relevancy scores.

In further embodiments, the sample social media data includes texts about social media (e.g. the text includes account, tweets, tags, title, author, content, and time etc.). In addition, the processor 130 can receive social media data through the transceiver from above-mentioned various social media databases.

In further embodiments, in step S201, the processor 130 can identify the text data from the social media data of the social media database 120(1).

In detail, in step S2011, the processor 130 can perform sentence segmentation, word hyphenation, removal of hyperlinks and punctuation on the social media data and the sample social media data to perform natural language processing (NPL), and use the processed sample social media data by NPL as training data, where the processed sample social media data includes multiple sample words and multiple sample sentences.

In step S2013, the processor 130 can label labels on the sample words and the sample sentences corresponding to processed sample social media data, where each label indicates whether each sample word or each sample sentence is related to the information security.

In step S2015, the processor 130 can use the labeled sample words and the labeled sample sentences to train a correlation identification model. For example, the processor 130 can perform operations related to long short-term memory (LSTM) algorithm on the labeled sample words and the labeled sample sentences. It is worth noting that the above-mentioned method of generating the correlation identification model can be any classification algorithm, and there is no special restriction for the method of generating the correlation identification model.

In step S2017, the processor 130 can calculate the multiple relevancy scores of the social media data by using the correlation identification model. By this way, the processor 130 can identify text data from the social media data according to the multiple relevancy scores. In detail, the processor 130 can identify text data which relevancy score is greater than a score threshold in the social media data.

In further embodiments, the processor 130 can identify multiple event subjects of the text data according to the sample social media data, where the multiple event subjects indicate multiple keywords relevant to multiple subjects of the text data. Accordingly, the processor 130 can label the text data with the multiple event subjects to generate second event information, and generate second event information according to labeled text data and the event information to store the second event information into the databases 120(1)˜120(N).

In further embodiments, in step S203, the processor 130 can identify the multiple event subjects of the text data, and label the text data with the multiple event subjects, and generate second event information according to labeled text data and the first event information to store the second event information into the event database 120(3).

In detail, in step S2031, the processor 130 can perform sentence segmentation, word hyphenation, removal of hyperlinks and punctuation on the social media data and the sample social media data to perform NPL, and use the processed sample social media data by NPL as training data, where the processed sample social media data includes multiple sample words and multiple sample sentences.

By this way, the processor 130 can label labels on the sample words and the sample sentences corresponding to processed sample social media data, where each label indicates sample event subject corresponding to each sample word or each sample sentence.

In step S2033, the processor 130 can use the labeled sample words and the labeled sample sentences to train a subject identification model. For example, the processor 130 can perform operations related to latent Dirichlet allocation (LDA) algorithm on the labeled sample words and the labeled sample sentences. It is worth noting that the above-mentioned method of generating the subject identification model can be any classification algorithm, and there is no special restriction for the method of generating the subject identification model.

In step S2035, the processor 130 can identify multiple event subjects of the text data by using the subject identification model. Accordingly, the processor 130 can label the text data with the multiple event, and generate second event information according to labeled text data and the first event information to store the second event information into the event database 120(3).

In detail, the processor 130 can identify multiple attack methods, multiple attack steps of the attack methods and multiple vulnerabilities corresponding to the attack methods according to the first event information, where those attack methods, those attack steps and those vulnerabilities correspond to the multiple event subjects of the labeled text data. Accordingly, the processor 130 can generate second event information according to those attack methods, those attack steps and those vulnerabilities. Therefore, the processor 130 can store the second event information into the event database 120(3).

In some embodiments, before the processor 130 reads the first vulnerability related information and the first event information from the databases 120(1)˜120(N), the processor 130 can receive vulnerability data through the transceiver, and calculate multiple exploit probabilities of the vulnerability data according to the first vulnerability related information. Therefore, the processor 130 can generate second vulnerability related information according to the multiple exploit probabilities and vulnerability data, and store the second vulnerability related information into the databases 120(1)˜120(N).

In further embodiments, the vulnerability data includes multiple types of multiple vulnerabilities and information related to attack methods, operating systems and threat types etc., where attack methods, operating systems and threat types etc. correspond to the multiple types of the multiple vulnerabilities. In addition, the processor 130 can receive data about new vulnerability through the transceiver from above-mentioned various external open source software vulnerability information databases or above-mentioned various external social media databases as the vulnerability data.

In further embodiments, the processor 130 can calculate multiple popularity degrees related to the first vulnerability related information according to sample social media data of the databases 120(1)˜120(N), where the multiple popularity degrees indicate frequencies of the first vulnerability related information appearing in the sample social media data. By this way, the processor 130 can generate multiple vulnerability features according to the first vulnerability related information and the multiple popularity degrees, and calculate the multiple exploit probabilities of the vulnerability data according to the multiple vulnerability features.

In further embodiments, in step S205, the processor 130 can calculate multiple exploit probabilities of the received vulnerability data according to the first vulnerability related information of the vulnerability database 120(2), and generate second vulnerability related information according to the multiple exploit probabilities and vulnerability data, so as to store the second vulnerability related information into the vulnerability database 120(2).

In detail, in step S2051, the processor 130 can generate multiple first vulnerability features (e.g. vulnerability description, CVSS score, CVE detail and zero-day and today price etc.) from the first vulnerability related information, and calculate the multiple popularity degrees of various vulnerabilities of the first vulnerability related information from sample social media data to use the multiple popularity degrees as multiple second vulnerability features, where the multiple popularity degrees indicate frequencies of the first vulnerability related information appearing in the sample social media data.

In step S2053, the processor 130 can use the multiple first vulnerability features, the multiple second vulnerability features and the first vulnerability related information to train an exploit prediction model. For example, the processor 130 can perform operations related to random forest algorithm on the multiple first vulnerability features, the multiple second vulnerability features and the first vulnerability related information. It is worth noting that the above-mentioned method of generating the exploit prediction model can be any classification algorithm, and there is no special restriction for the method of generating the exploit prediction model.

In step S2055, the processor 130 can calculate the multiple exploit probabilities of the vulnerability data by using the exploit prediction model, and generate the second vulnerability related information according to the multiple exploit probabilities and the vulnerability data, and store the second vulnerability related information into the vulnerability database 120(2), where the exploit probability indicates a probability which one vulnerability among vulnerability data will be exploited and attacked in the future.

In detail, the processor 130 can identify multiple threat levels of the vulnerability data according to multiple probability thresholds. Based on this, the processor 130 can generate the second vulnerability related information according to the multiple threat levels and the vulnerability data. Therefore, the processor 130 can store the second vulnerability related information into the vulnerability database 120(2).

In step S303, the processor 130 can generate at least one first intelligent graph according to the first vulnerability related information and the first event information, and generate a second intelligent graph according to the scenario information.

In other words, the processor 130 can generate at least one first intelligent graph corresponding to the first vulnerability related information based on the first vulnerability related information, and generate a second intelligent graph corresponding to the scenario information based on the scenario information.

In some embodiments, the processor 130 can read the scenario information and the IOC data from the event database 120(3) and the IOC database 120(5) respectively, and generate the second intelligent graph corresponding to the scenario information based on the scenario information and the IOC data.

In some embodiments, the processor 130 can generate multiple first intelligent subgraphs according to the first vulnerability related information, and generate multiple second intelligent subgraphs according to the first event information. Accordingly, the processor 130 can link at least one of the multiple first intelligent subgraphs and at least one of the multiple second intelligent subgraphs to generate the at least one first intelligent graph, where the at least one of the multiple first intelligent subgraphs is related to the at least one of the multiple second intelligent subgraphs.

In further embodiments, the processor 130 can link at least one first node in the at least one of the multiple first intelligent subgraphs to at least one second node in the at least one of the multiple second intelligent subgraphs, where the at least one first node is same as the at least one second node.

In some embodiments, in step S2071 among step S207, the processor 130 can generate the multiple first intelligent subgraphs corresponding to the first vulnerability related information of the vulnerability database 120(2), and generate the multiple second intelligent subgraphs corresponding to the first event information of the event database 120(3), so as to link the at least one of the multiple first intelligent subgraphs and the at least one of the multiple second intelligent subgraphs related to the at least one of the multiple second intelligent subgraphs to generate the at least one first intelligent graph.

In detail, the processor 130 can search the at least one first node which is in the at least one of the multiple first intelligent subgraphs and is same as the at least one second node in the at least one of the multiple second intelligent subgraphs. By this way, the processor 130 can link all first node and all second node to generate the at least one first intelligent graph.

For example, when the processor 130 has searched ten second nodes in ten second intelligent subgraphs which are same as ten first nodes in ten first intelligent subgraphs respectively, the processor 130 can link ten first nodes and ten second nodes respectively to generate ten first intelligent graphs.

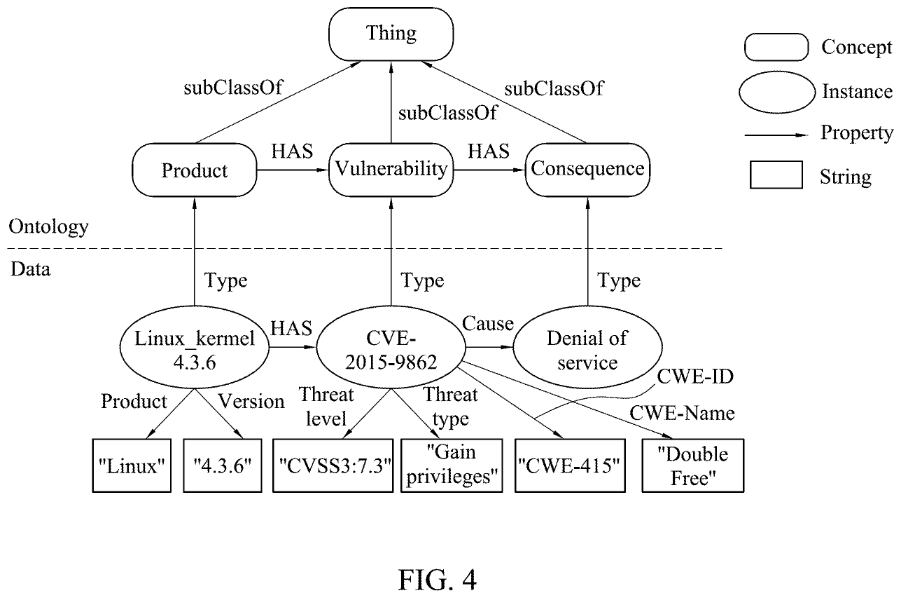

In another example, FIG. 4 is a schematic diagram of the first intelligent subgraph according to an embodiment of the present disclosure. Referring to FIG. 4, the first intelligent subgraph is related to one of vulnerability in the first vulnerability related information. Moreover, the first intelligent subgraph indicates all related information about one of vulnerability.

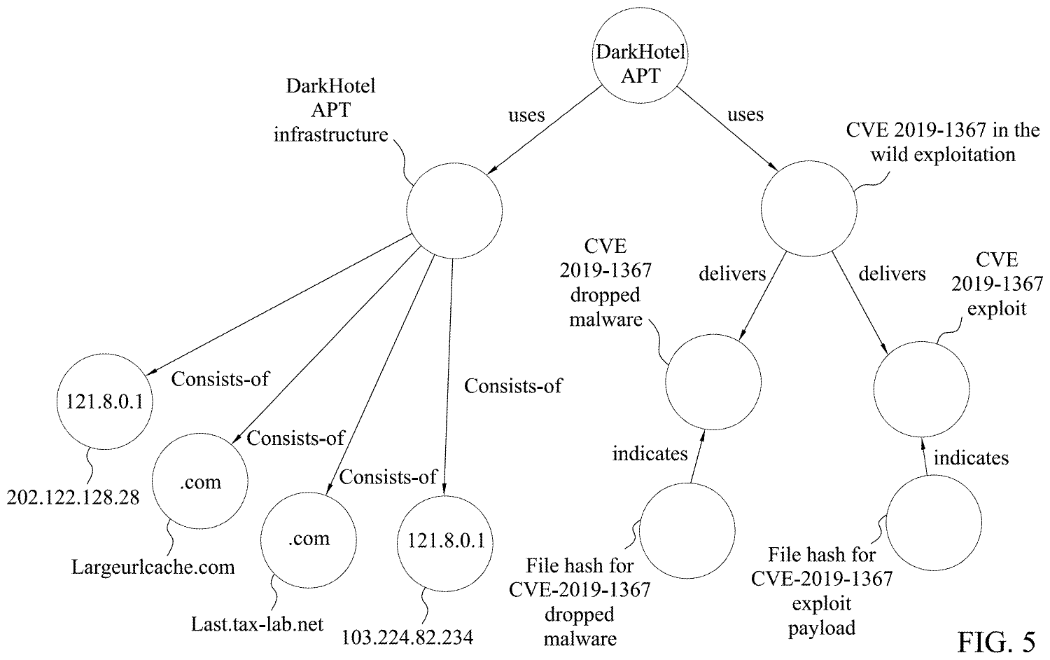

In another example, FIG. 5 is a schematic diagram of the second intelligent subgraph according to an embodiment of the present disclosure. Referring to FIG. 5, the second intelligent subgraph is related to one information security event in the first event information. Moreover, this second intelligent subgraph includes the attack method (i.e. DarkHotel APT), the infrastructure (which consists of four elements (i.e. two “.com” elements and two “121.8.3.1” elements)) of the attack method, the vulnerability (i.e. CVE-2019-1367) corresponding to the attack method and the exploitation (i.e. CVE-2019-1367 in the wild exploitation which delivers CVE-2019-1367 dropped malware and CVE-2019-1367 exploit, and the CVE-2019-1367 dropped malware and the CVE-2019-1367 exploit are indicated by File hash for CVE-2019-1367 dropped malware and File hash for CVE-2019-1367 exploit payload respectively) of the vulnerability.

Finally, referring to FIG. 1, FIG. 2 and FIG. 3 at the same time, in step S305, the processor 130 can compare the at least one first intelligent graph with the second intelligent graph to identify at least one similarity between the at least one first intelligent graph and the second intelligent graph for determining whether the company has information security threat.

In other words, the processor 130 can identify at least one similarity between the at least one first intelligent graph and the second intelligent graph by comparing the at least one first intelligent graph with the second intelligent graph. By this way, the processor 130 can determine whether the company has the information security threat based on the at least one similarity.

In some embodiments, the processor 130 can identify multiple first reference nodes from multiple nodes of the at least one first intelligent graph. Therefore, the processor 130 can determine whether at least one second reference node matched to at least one of the multiple first reference nodes exists in the second intelligent graph.

In further embodiments, the processor 130 can extract at least one intelligent subgraph corresponding to the at least one first reference node from the second intelligent graph when the at least one second reference node corresponding to the multiple first reference node existing in the second intelligent graph. By this way, the processor 130 can calculate at least one match degree between the at least one intelligent subgraph and the at least one first intelligent graph, and determine whether at least one of the at least one match degree is greater than a threshold, where the at least one match degree indicates the at least one similarity.

In some embodiments, in step S2073 among step S207, the processor 130 can generate the second intelligent graph based on the scenario information among the event database 120(3) and the IOC data among the IOC database 120(5), and determine whether at least one second reference node matched to at least one of the multiple first reference nodes exists in the second intelligent graph. It is worth noting that the second intelligent graph has similar structure to the above-mentioned second intelligent subgraph.

In detail, the processor 130 can link multiple nodes corresponding to the scenario information and multiple nodes corresponding to the IOC data according to the relationship between the scenario information and the IOC data (e.g. when a IOC among the IOC data is related to OS version among the scenario information, the processor 130 can link the node corresponding to the IOC to the node corresponding to the OS version) to generate the second intelligent graph.

Furthermore, the processor 130 can calculate importance values of all nodes of the at least one first intelligent graph, and search the multiple first reference nodes which the importance values are greater than an importance threshold. In addition, the processor 130 also can perform operations related to graph path finding algorithm on the at least one first intelligent graph to identify the multiple first reference nodes. Besides, the processor 130 also can identify the multiple first reference nodes which correspond to multiple vulnerabilities in the at least one first intelligent graph. Therefore, there is no special restriction for identifying the multiple first reference nodes in the at least one first intelligent graph.

Based on above, when the processor 130 has determined no second reference node matched to at least one of the multiple first reference nodes exists in the second intelligent graph, the processor 130 can determine the company does not have the information security threat. On contrary, when the processor 130 has determined the at least one second reference node matched to at least one of the multiple first reference nodes exists in the second intelligent graph, the processor 130 can extract the at least one intelligent subgraph corresponding to the at least one second reference node from the second intelligent graph.

For example, the processor 130 can perform trust rank algorithm, random walk algorithm or pagerank algorithm on the at least one second reference node to extract the at least one intelligent subgraph from the second intelligent graph. Therefore, there is no special restriction for method of extracting the at least one intelligent subgraph from the second intelligent graph.

Further, in step S2075, the processor 130 can calculate the at least one match degree between the at least one intelligent subgraph and the at least one first intelligent graph. In detail, the processor 130 can perform graph matching algorithm between the at least one intelligent subgraph and the at least one first intelligent graph to calculate the at least one match degree corresponding to the at least one similarity.

In some embodiments, the processor 130 can identify at least one potential vulnerability corresponding to the at least one of the at least one match degree for determining whether the company has the information security threat when the at least one of the at least one match degree is greater than the threshold.

In some embodiments, in step S2077, the processor 130 can identify the at least one potential vulnerability corresponding to the at least one of the at least one match degree for determining whether the company has the information security threat when the at least one of the at least one match degree is greater than the threshold. In detail, when the at least one of the at least one match degree is greater than the threshold, the processor 130 can identify the intelligent subgraph corresponding to the match degree, which is greater than the threshold, and identify the vulnerability corresponding to the node of the intelligent subgraph as the potential vulnerability.

In some embodiments, the processor 130 can transmit data of the at least one potential vulnerability to external warning device, and the external warning device can generate warning message according to the data of the at least one potential vulnerability. Accordingly, through the external warning device, the user can be aware of what vulnerability in the company will be attacked according to the warning message, and can know that the company has the information security threat according to the warning message.

In some embodiments, the information security device 100 further comprises display (not shown). The processor 130 can generate the warning message according to the data of the at least one potential vulnerability, so as to display the warning message through the display. Accordingly, through the display, the user can be aware of what vulnerability in the company will be attacked according to the warning message, and can know that the company has the information security threat according to the warning message.

In summary, the information security device and method thereof in the disclosure use the intelligence graph corresponding to the scenario of the company and the intelligence graph corresponding to the information security event of the databases to perform graph matching analysis, so as to identify the vulnerability of the scenario that will be attacked in the future. In addition, it can further search useful information about information security from online social media and vulnerability related databases. By this way, the information security device and method thereof in the disclosure can solve the problem of how to obtain the threat information and to filter and overcome the threat information.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An information security device, comprising:
a transceiver configured to receive scenario information of a company;
a register configured to store a plurality of instructions and a plurality of databases; and
a processor coupled to the transceiver and the register, and configured to execute the plurality of instructions to:
read first vulnerability related information and first event information from the plurality of databases;
generate at least one first intelligent graph according to the first vulnerability related information and the first event information, and generate a second intelligent graph according to the scenario information; and
compare the at least one first intelligent graph with the second intelligent graph to identify at least one similarity between the at least one first intelligent graph and the second intelligent graph for determining whether the company has information security threat.

2. The information security device of claim 1, wherein the processor is further configured to:
receive social media data through the transceiver, and calculate a plurality of relevancy scores of the social media data according to sample social media data of the plurality of databases, wherein the plurality of relevancy scores indicate correlation between the social media data and information security; and
identify text data from the social media data according to the plurality of relevancy scores.

3. The information security device of claim 2, wherein the processor is further configured to:
identify a plurality of event subjects of the text data according to the sample social media data, wherein the plurality of event subjects indicate a plurality of keywords relevant to a plurality of subjects of the text data; and
label the text data with the plurality of event subjects, and generate second event information according to labeled text data and the first event information, and store the second event information into the plurality of databases.

4. The information security device of claim 1, wherein the processor is further configured to:
receive vulnerability data through the transceiver, and calculate a plurality of exploit probabilities of the vulnerability data according to the first vulnerability related information; and
generate second vulnerability related information according to the plurality of exploit probabilities and vulnerability data, and store the second vulnerability related information into the plurality of databases.

5. The information security device of claim 4, wherein the processor is further configured to:
calculate a plurality of popularity degrees related to the first vulnerability related information according to sample social media data of the plurality of databases, wherein the plurality of popularity degrees indicates frequencies of the first vulnerability related information appearing in the sample social media data;
generate a plurality of vulnerability features according to the first vulnerability related information and the plurality of popularity degrees; and
calculate the plurality of exploit probabilities of the vulnerability data according to the plurality of vulnerability features.

6. The information security device of claim 1, wherein the processor is further configured to:
generate a plurality of first intelligent subgraphs according to the first vulnerability related information, and generate a plurality of second intelligent subgraphs according to the first event information; and
link at least one of the plurality of first intelligent subgraphs and at least one of the plurality of second intelligent subgraphs to generate the at least one first intelligent graph, wherein the at least one of the plurality of first intelligent subgraphs is related to the at least one of the plurality of second intelligent subgraphs.

7. The information security device of claim 6, wherein the processor is further configured to:
link at least one first node in the at least one of the plurality of first intelligent subgraphs to at least one second node in the at least one of the plurality of second intelligent subgraphs, wherein the at least one first node is same as the at least one second node.

8. The information security device of claim 1, wherein the processor is further configured to:
identify a plurality of first reference nodes from a plurality of first nodes of the at least one first intelligent graph; and
determine whether at least one second reference node matched to at least one of the plurality of first reference node exists in the second intelligent graph.

9. The information security device of claim 8, wherein the processor is further configured to:
extract at least one intelligent subgraph corresponding to the at least one first reference node from the second intelligent graph when the at least one second reference node corresponding to the plurality of first reference node existing in the second intelligent graph; and
calculate at least one match degree between the at least one intelligent subgraph and the at least one first intelligent graph, and determine whether at least one of the at least one match degree is greater than a threshold, wherein the at least one match degree indicates the at least one similarity.

10. The information security device of claim 9, wherein the processor is further configured to:
identify at least one potential vulnerability corresponding to the at least one of the at least one match degree for determining whether the company has the information security threat when the at least one of the at least one match degree is greater than the threshold.

11. An information security method, comprising:
reading first vulnerability related information and first event information from a plurality of databases;
generating at least one first intelligent graph according to the first vulnerability related information and the first event information, and generate a second intelligent graph according to the scenario information; and
calculating at least one match degree between the at least one first intelligent graph and the second intelligent graph for determining whether the company has information security threat.

12. The information security method of claim 11, further comprising:
receiving social media data, and calculating a plurality of relevancy scores of the social media data according to sample social media data of the plurality of databases, wherein the plurality of relevancy scores indicate correlation between the social media data and information security; and
identifying text data from the social media data according to the plurality of relevancy scores.

13. The information security method of claim 12, further comprising:
identifying a plurality of event subjects of the text data according to the sample social media data, wherein the plurality of event subjects indicate a plurality of keywords relevant to a plurality of subjects of the text data; and
labeling the text data with the plurality of event subjects, and generating second event information according to labeled text data and the first event information to store the second event information into the plurality of databases.

14. The information security method of claim 11, further comprising:
receiving vulnerability data, and calculating a plurality of exploit probabilities of the vulnerability data according to the first vulnerability related information; and
generating second vulnerability related information according to the plurality of exploit probabilities and vulnerability data, and store the second vulnerability related information into the plurality of databases.

15. The information security method of claim 14, wherein the step of calculating a plurality of exploit probabilities of the vulnerability data according to the first vulnerability related information comprises:
calculating a plurality of popularity degrees related to the first vulnerability related information according to sample social media data of the plurality of databases, wherein the plurality of popularity degrees indicate frequencies of the first vulnerability related information appearing in the sample social media data;
generating a plurality of vulnerability features according to the first vulnerability related information and the plurality of popularity degrees; and
calculating the plurality of exploit probabilities of the vulnerability data according to the plurality of vulnerability features.

16. The information security method of claim 11, wherein the step of generating the at least one first intelligent graph according to the first vulnerability related information and the first event information comprises:
generating a plurality of first intelligent subgraphs according to the first vulnerability related information, and generate a plurality of second intelligent subgraphs according to the first event information; and
linking at least one of the plurality of first intelligent subgraphs and at least one of the plurality of second intelligent subgraphs to generate the at least one first intelligent graph, wherein the at least one of the plurality of first intelligent subgraphs is related to the at least one of the plurality of second intelligent subgraphs.

17. The information security method of claim 16, wherein the step of linking the at least one of the plurality of first intelligent subgraphs and the at least one of the plurality of second intelligent subgraphs to generate the at least one first intelligent graph comprises:
linking a first node in the at least one of the plurality of first intelligent subgraphs to a second node in the at least one of the plurality of second intelligent subgraphs, wherein the first node is the same as the second node.

18. The information security method of claim 11, wherein the step of calculating the at least one match degree between the at least one first intelligent graph and the second intelligent graph to determine whether the company has the information security threat comprises:
identifying a plurality of first reference nodes from a plurality of nodes of the at least one first intelligent graph; and
determining whether at least one second reference node matched to at least one of the plurality of first reference node exists in the second intelligent graph.

19. The information security method of claim 18, further comprising:
extracting at least one intelligent subgraph corresponding to the at least one first reference node from the second intelligent graph when the at least one second reference node corresponding to the plurality of first reference node existing in the second intelligent graph; and
calculating at least one match degree between the at least one intelligent subgraph and the at least one first intelligent graph, and determine whether at least one of the at least one match degree is greater than a threshold.

20. The information security method of claim 19, further comprising:
identifying at least one potential vulnerability corresponding to the at least one of the at least one match degree for determining whether the company has the information security threat when the at least one of the at least one match degree is greater than the threshold.
